(19) United States
(12) Patent Application Publication
(10) Pub. No.: US 2025/0020991 A1
(43) Pub. Date: Jan. 16, 2025

(54) DISPLAY SYSTEM FOR REAR PROJECTION

(71) Applicant: FUJIFILM Corporation, Tokyo (JP)

(72) Inventors: Yujiro YANAI, Minamiashigara-shi (JP); Hirofumi TOYAMA, Minamiashigara-shi (JP)

(73) Assignee: FUJIFILM Corporation, Tokyo (JP)

(21) Appl. No.: 18/887,894

(22) Filed: Sep. 17, 2024

Related U.S. Application Data
(63) Continuation of application No. PCT/JP2023/011902, filed on Mar. 24, 2023.

(30) Foreign Application Priority Data
Mar. 30, 2022 (JP) 2022-055873

(51) Int. Cl. G03B 21/62; G02B 5/30; G02F 1/1335; G02F 1/137; G03B 21/10

(52) U.S. Cl. CPC G03B 21/62; G02B 5/3016; G02F 1/133504; G02F 1/13718; G03B 21/10

(57) ABSTRACT

Provided is a display system for rear projection including a transparent screen where a background is visible, in which visibility of a video can be improved. The display system for rear projection includes: a projection device that emits video light; and a transparent screen on which the video light emitted from the projection device is projected, in which at a point that is positioned on the video light projected on the transparent screen and is closest to a projection opening of the projection device, an angle θ₁ between a ray of the video light projected on the point and a normal line of the transparent screen is 30° or more.

### CROSS-REFERENCE TO RELATED APPLICATIONS

This application is a Continuation of PCT International Application No. PCT/JP2023/011902 filed on Mar. 24, 2023, which claims priority under 35 U.S.C. § 119(a) to Japanese Patent Application No. 2022-055873 filed on Mar. 30, 2022. The above applications are hereby expressly incorporated by reference, in their entirety, into the present application.

### BACKGROUND OF THE INVENTION

### 1. Field of the Invention

The present invention relates to a display system for rear projection.

### 2. Description of the Related Art

Recently, as one display system, a rear projection type display system including a transparent screen where video light projected from a projection device disposed on the rear side is directed to the front side to display a video and a background is visible is known.

For example, JP2018-013634A describes a transmissive screen that displays transmitted video light, the transmissive screen including: an incidence surface into which the video light is incident; an emission surface that faces the incidence surface and emits the video light; and a plurality of total reflecting surfaces that are positioned between the incidence surface and the emission surface in a thickness direction of the transmissive screen, are arranged along a predetermined direction, and totally reflect at least a part of the video light incident from the incidence surface to the emission surface, in which an angle between the total reflecting surface and a connection surface formed by an emission-side end part of the total reflecting surface and an incidence-side end part of the total reflecting surface adjacent to the emission-side end part is an acute angle.

### SUMMARY OF THE INVENTION

In a display system for rear projection including a transparent screen where a background is visible, video light from a projection device is incident into the transparent screen from an oblique direction and is displayed toward substantially the front by the transparent screen. However, the transparent screen where a background is visible has high light-transmitting property. Therefore, a part of the video light projected from the projection device travels linearly and transmits through the transparent screen without a traveling direction thereof being bent. In a case where the linearly transmitted light is recognized by a viewer, there is a problem in that the linearly transmitted light overlaps the video light directed toward substantially the front by the transparent screen such that visibility deteriorates.

An object of the present invention is to solve the above-described problem of the related art and to provide a display system for rear projection including a transparent screen where a background is visible, in which visibility of a video can be improved.

In order to achieve the object, the present invention has the following configurations.

[1] A display system for rear projection comprising:
a projection device that emits video light; and
a transparent screen on which the video light emitted from the projection device is projected,
in which at a point that is positioned on the video light projected on the transparent screen and is closest to a projection opening of the projection device, an angle θ₁ between a ray of the video light projected on the point and a normal line of the transparent screen is 30° or more.

[2] The display system for rear projection according to [1],
in which the angle θ₁ is 30° to 60°.

[3] The display system for rear projection according to [1] or [2],
in which the transparent screen includes a light projection layer that directs the projected video light toward a visible side, and
a film thickness of the light projection layer is 0.1 μm to 30 μm.

[4] The display system for rear projection according to [3],
in which the film thickness of the light projection layer is 2 μm to 12 μm.

[5] The display system for rear projection according to [3] or [4],
in which the light projection layer is a light scattering layer that includes light scattering particles, and
the angle θ₁ is 45° to 60°.

[6] The display system for rear projection according to [3] or [4],
in which the light projection layer is a cholesteric liquid crystal layer,
in a cross section perpendicular to a main surface of the cholesteric liquid crystal layer, a bright portion and a dark portion derived from a cholesteric liquid crystalline phase observed with a scanning electron microscope are tilted with respect to the main surface of the cholesteric liquid crystal layer, and
the angle θ₁ is 30° to 60°.

[7] The display system for rear projection according to [6],
in which the bright portion and the dark portion of the cholesteric liquid crystal layer are tilted by 20° to 90° with respect to the main surface of the cholesteric liquid crystal layer.

[8] The display system for rear projection according to any one of [1] to [7],
in which a haze of the transparent screen is 25% or less.

[9] The display system for rear projection according to any one of [1] to [8],
in which a light transmittance of the transparent screen is 80% or more.

According to the present invention, it is possible to provide a display system for rear projection including a transparent screen where a background is visible, in which visibility of a video can be improved

### BRIEF DESCRIPTION OF THE DRAWINGS

FIG. 1 is a schematic diagram showing an example of a display system for rear projection according to the present invention.

FIG. 2 is a diagram conceptually showing an example of a cholesteric liquid crystal layer in the display system for rear projection according to the present invention.

FIG. 3 is a plan view showing a cholesteric liquid crystal layer shown in FIG. 2.

FIG. 4 is a diagram conceptually showing a cross-sectional SEM image of the cholesteric liquid crystal layer shown in FIG. 2.

FIG. 5 is a schematic diagram showing a method of manufacturing the cholesteric liquid crystal layer shown in FIG. 2.

FIG. 6 is a diagram conceptually showing an example of a light diffusion layer in the display system for rear projection according to the present invention.

### DESCRIPTION OF THE PREFERRED EMBODIMENTS

Hereinafter, the details of the present invention will be described. In the present specification, numerical ranges represented by “to” include numerical values before and after “to” as lower limit values and upper limit values.

In addition, in the present specification, “(meth)acrylate” represents both of acrylate and methacrylate, “(meth)acryloyl group” represents both of an acryloyl group and a methacryloyl group, and “(meth)acryl” represents both of acryl and methacryl.

In the present specification, the meaning of the term “the same” or the like includes a case where an error range is generally allowable in the technical field. In addition, in the present specification, the term “the same” or the like regarding an angle represents that a difference from the exact angle is within a range of less than 5 degrees unless otherwise specified. The difference from the exact angle is preferably less than 4 degrees and more preferably less than 3 degrees.

### Display System for Rear Projection

A display system for rear projection according to an embodiment of the present invention comprises:
a projection device that emits video light; and
a transparent screen on which the video light emitted from the projection device is projected,
in which at a point that is positioned on the video light projected on the transparent screen and is closest to a projection opening of the projection device, an angle θ₁ between a ray of the video light projected on the point and a normal line of the transparent screen is 30° or more.

The use of the display system for rear projection according to the embodiment of the present invention is not particularly limited, and preferable examples thereof include a use where an image is projected on a window of a public facility, a vehicle, or the like. Specifically, the display system for rear projection according to the embodiment of the present invention is particularly suitable for a use for a window of a store, a window of a vehicle (an automobile, a bus, or a train), or the like.

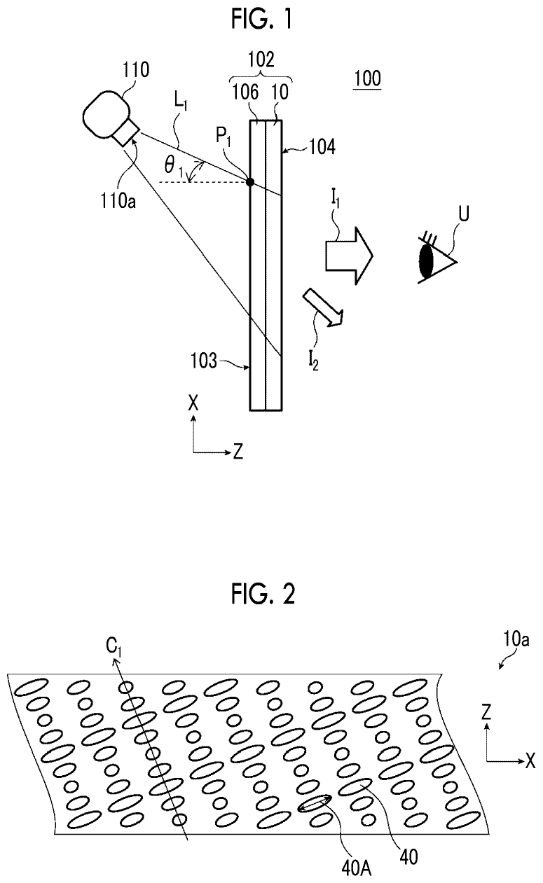

FIG. 1 schematically shows an example of the display system for rear projection according to the embodiment of the present invention.

A display system 100 for rear projection shown in FIG. 1 includes a projection device 110 and a transparent screen 102. In the example shown in FIG. 1, the transparent screen 102 has a configuration where a light projection layer 10 is laminated on a support 106.

The projection device 110 is disposed on a rear surface 103 side of the transparent screen 102. The projection device 110 emits video light and projects the video light from the rear surface 103 side to the transparent screen 102. The video light emitted from the projection device 110 is planar light. In addition, as shown in FIG. 1, the projection device 110 projects the video light to the rear surface 103 of the transparent screen 102 from an oblique direction.

The transparent screen 102 displays the video light emitted to the rear surface 103 side toward substantially the front direction of a front surface 104 side. That is, as indicated by arrow I₁ in FIG. 1, light incident into the rear surface 103 from an oblique direction transmits through the transparent screen 102 in a direction substantially perpendicular to the front surface 104 such that a video is recognized by an observer U on the front surface 104 side. In the example shown in FIG. 1, the transparent screen 102 includes the light projection layer 10 and the support 106 that supports the light projection layer 10, and the light projection layer 10 acts to direct the video light incident from an oblique direction in the direction substantially perpendicular to the front surface 104. Examples of the light projection layer 10 include a light scattering layer including light scattering particles and a cholesteric liquid crystal layer. The light projection layer 10 will be described below in detail.

In the present invention, a main surface of the transparent screen 102 on the observer U side refers to the front surface, and a main surface of the transparent screen 102 on the projection device 110 side refers to the rear surface. The main surface is the maximum surface of a sheet-like material (a plate-like material, a film, or the like).

In the display system 100 for rear projection, the projection device 110 emits video light from the rear surface 103 side to the transparent screen 102 such that the video light is visible to the observer U from the front surface 104 side and a scenery (background) on the rear surface 103 side of the transparent screen 102 is visible.

Here, in the display system 100 for rear projection according to the embodiment of the present invention, as shown in FIG. 1, in a case where a point that is positioned on the video light projected on the rear surface 103 of the transparent screen 102 and is closest to a projection opening 110a of the projection device 110 is represented by a point P₁, a ray of the video light projected on the point P₁ is represented by L₁, and an angle between the ray L₁ and a normal line of the main surface (rear surface 103) of the transparent screen 102 is represented by θ₁, the angle θ₁ is 30° or more. In other words, in a case where a point on the rear surface 103 closest to the projection opening 110a of the projection device 110 is represented by the point P₁ and a line of the video light connecting the point P₁ and a point of the projection opening 110a closest to the transparent screen 102 is represented by the ray L₁, the angle θ₁ between the ray L₁ and the normal line of the main surface (rear surface 103) of the transparent screen 102 is 30° or more.

As described above, in the display system for rear projection including the transparent screen where a background is visible, the light-transmitting property of the transparent screen is high. Therefore, as indicated by arrow I₂ in FIG. 1, a part of the video light projected from the projection device travels linearly and transmits through the transparent screen without a traveling direction thereof being bent. In a case where the linearly transmitted light I₂ is recognized by the observer U, there is a problem in that the linearly transmitted light overlaps the video light I₁ directed toward substantially the front by the transparent screen such that visibility deteriorates.

On the other hand, the display system 100 for rear projection according to the embodiment of the present invention has the configuration where the angle θ₁ between the ray L₁ of the video light projected on the point P₁ and the normal line of the transparent screen 102 is 30° or more, the point P₁ being positioned on the video light projected on the transparent screen 102 and being closest to the projection opening 110a of the projection device 110. As a result, the linearly transmitted light I₂ that travels linearly without the traveling direction being bent by the transparent screen 102 is not likely to be recognized by the observer U. Therefore, the overlapping of the linearly transmitted light I₂ and the video light I₁ directed to substantially the front by the transparent screen 102 is suppressed, and the visibility can be improved.

From the viewpoint of suppressing the effect of the linearly transmitted light I₂ to improve the visibility, the angle θ₁ is preferably 30° or more and more preferably 35° or more.

On the other hand, when the angle θ₁ is excessively large, an angle at which the transparent screen 102 directs the video light I₁ to the front excessively increases. Therefore, the amount of the video light I₁ decreases, and the light-transmitting property may decrease. For example, as described below, in the configuration where the transparent screen 102 includes the light scattering layer, in order for the transparent screen 102 to largely change the traveling direction (angle) of the video light I₁, the scattering power of the light scattering layer needs to be set to be high. However, when the scattering power is set to be high, the light-transmitting property decreases. From the viewpoint of suppressing a decrease in the amount of the video light I₁ directed to the front and suppressing a decrease in light transmittance, the angle θ₁ is preferably 60° or less and more preferably 55° or less.

In addition, in the configuration where the transparent screen 102 includes the light projection layer 10 acts to direct the video light to the visible side, a film thickness of the light projection layer 10 is preferably 0.1 μm to 30 μm, more preferably 2 μm to 12 μm, and still more preferably 5 μm to 10 μm. By adjusting the film thickness of the light projection layer 10 to be 0.1 μm or more, the video light incident from an oblique direction can be more reliably directed to the front, and the amount of the video light I₁ directed to the front can be improved. In addition, by adjusting the film thickness of the light projection layer 10 to be 30 μm or less, a decrease in light transmittance can be suppressed.

In addition, from the viewpoint of the light-transmitting property, a haze of the transparent screen 102 is preferably 25% or less, more preferably 22.5% or less, and still more preferably 20% or less.

In the present specification, “haze” refers to a value measured using a haze meter NDH-2000 (manufactured by Nippon Denshoku Industries Co., Ltd.).

Theoretically, the haze refers to a value represented by the following expression.

(Diffuse Transmittance of Natural Light at 380 to 780 nm)/(Diffuse Transmittance of Natural Light at 380 to 780 nm+Direct Transmittance of Natural Light)×100%

The diffuse transmittance is a value calculated by subtracting the direct transmittance from a total transmittance obtained using a spectral photometer and an integrating sphere unit. The direct transmittance is a transmittance at 0° based on the value measured using the integrating sphere unit. That is, the low haze represents that the amount of directly transmitted light is more than the amount of total transmitted light.

In addition, from the viewpoint of improving the visibility of a background, a light transmittance of the transparent screen 102 with respect to visible light is preferably 80% or more, more preferably 82.5% or more, and still more preferably 85% or more. The light transmittance can be measured using a spectral photometer (VAP-7070, manufactured by JASCO Corporation).

Hereinafter, the components of the display system for rear projection according to the embodiment of the present invention will be described.

### Projection Device

In the display system for rear projection according to the embodiment of the present invention, the projection device is not limited, and various well-known projection devices (display devices and projectors) used for the display system for rear projection or the like can be used. Examples of the projection device include a projection device including a display and a projection lens.

In the display system for rear projection according to the embodiment of the present invention, the display is not particularly limited. For example, various well-known displays used in AR glasses or the like can be used.

Examples of the display include a liquid crystal display (including Liquid Crystal On Silicon (LCOS)), an organic electroluminescent display, and a scanning type display employing a digital light processing (DLP) or Micro Electro Mechanical Systems (MEMS) mirror.

In a configuration where the display system for rear projection displays a polychromic image, a display that displays a polychromic image is used.

In the projection device used in the display system for rear projection according to the embodiment of the present invention, the projection lens is also a well-known projection lens (collimating lens) used for the display system for rear projection or the like.

### Transparent Screen

The transparent screen displays the video light emitted from an oblique direction to the rear side toward substantially the front direction of the front side. In the display system for rear projection according to the embodiment of the present invention, the transparent screen is not limited, and various well-known transparent screens used for the display system for rear projection or the like can be used.

As shown in FIG. 1, the transparent screen may be configured to include: the light projection layer that acts to direct the video light incident from an oblique direction in the direction substantially perpendicular to the front surface; and the support that supports the light projection layer. In addition, the transparent screen may include a layer other than the light projection layer and the support.

### <Support>

As the support, various sheet-like materials (such as a film and a plate-like material) can be used as long as these materials can support the light projection layer. A transmittance of the support with respect to corresponding light, that is, visible light is preferably 50% or more, more preferably 70% or more, and still more preferably 85% or more.

A thickness of the support is not particularly limited and may be appropriately set depending on a material for forming the support and the like in a range where the light projection layer can be supported. The thickness of the support is preferably 1 to 2000 μm, more preferably 3 to 500 μm, and still more preferably 5 to 250 μm.

The support may have a monolayer structure or a multi-layer structure. In a case where the support has a monolayer structure, examples thereof include supports formed of a resin such as glass, triacetyl cellulose (TAC), polyethylene terephthalate (PET), polycarbonates, polyvinyl chloride, acryl, or polyolefin. Alternatively, a glass substrate may be used as the support. In a case where the support has a multi-layer structure, examples thereof include a support including: one of the above-described supports having a monolayer structure that is provided as a substrate; and another layer that is provided on a surface of the substrate.

As the support, a support during the formation of the light projection layer may be used, or the light projection layer may be formed on another temporary support and subsequently transferred to the support.

### <Light Projection Layer>

As the light projection layer, various well-known light projection layers used for a transparent screen can be used as long as they can act to direct the video light incident from an oblique direction in the direction substantially perpendicular to the front surface. Examples of the light projection layer include a light scattering layer including light scattering particles and a cholesteric liquid crystal layer.

### <<Cholesteric Liquid Crystal Layer>>

In a cross section perpendicular to a main surface of the cholesteric liquid crystal layer used as the light projection layer, a bright portion and a dark portion derived from a cholesteric liquid crystalline phase observed with a scanning electron microscope (SEM) are tilted with respect to the main surface (normal direction of the main surface) of the cholesteric liquid crystal layer.

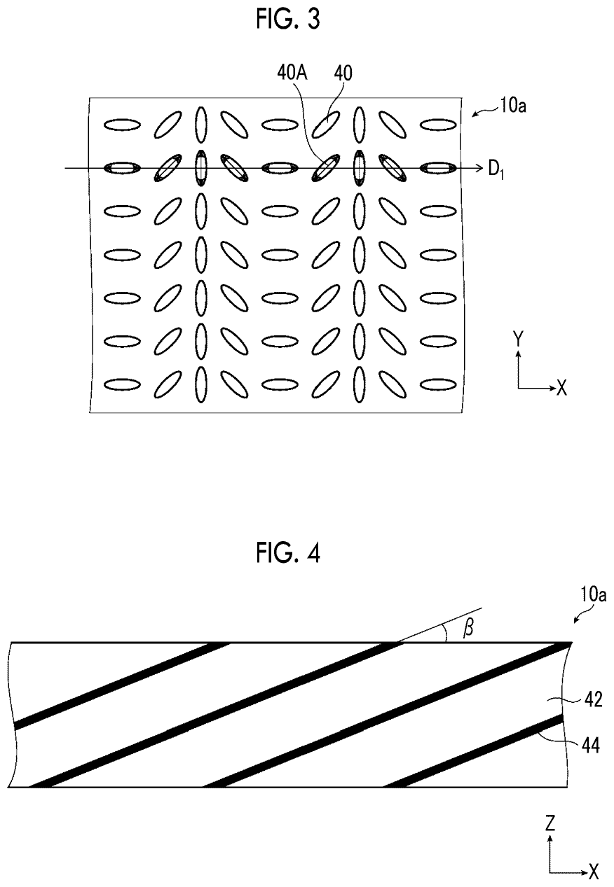

FIG. 2 is a diagram conceptually showing an example of an alignment state of a liquid crystal compound in the cholesteric liquid crystal layer used as the light projection layer. FIG. 3 is a plan view showing the cholesteric liquid crystal layer shown in FIG. 2. FIG. 4 is a diagram conceptually showing a cross-sectional SEM image obtained by observing a cross section of the cholesteric liquid crystal layer shown in FIG. 2 perpendicular to the main surface with a SEM.

In FIGS. 2 to 4, a direction X and a direction Y represent orientations of two coordinate axes orthogonal to each other on the main surface of the cholesteric liquid crystal layer. A direction Z is a direction perpendicular to the main surface of the cholesteric liquid crystal layer. FIGS. 2 and 4 are diagrams showing an X-Z plane, in which a direction perpendicular to the paper plane is the Y direction. FIG. 3 is a diagram showing an X-Y plane, in which a direction perpendicular to the paper plane is the Z direction. In addition, in FIG. 1, the transparent screen 102 is disposed such that the direction Z is the left-right direction in the drawing.

A cholesteric liquid crystal layer 10a is a layer obtained by cholesterically aligning a liquid crystal compound 40 to immobilize a cholesteric liquid crystalline phase. The example shown in FIGS. 2 and 3 is an example where the liquid crystal compound is a rod-like liquid crystal compound. The cholesteric liquid crystal layer according to the embodiment of the present invention is not limited as long as the optical characteristics of the cholesteric liquid crystalline phase are maintained, and the liquid crystal compound in the layer does not necessarily exhibit liquid crystallinity.

As shown in FIG. 2, the cholesteric liquid crystal layer 10a includes the liquid crystal compound 40. The liquid crystal compound 40 is helically arranged along a helical axis C₁. That is, the cholesteric liquid crystal layer 10a has a helical structure in which the liquid crystal compound 40 is helically turned and laminated. In the helical structure, a configuration in which the liquid crystal compound 40 is helically turned once (rotated by 360) and laminated is set as one helical pitch, and plural pitches of the helically turned liquid crystal compound 40 are laminated.

The helical axis C₁ is orthogonal to an optical axis 40A of the liquid crystal compound 40. The helical axis C₁ is tilted with respect to each of perpendicular lines of the two main surfaces of the cholesteric liquid crystal layer 10a. A region where the orientation of the optical axis 40A is parallel (including a position substantially parallel) to an observation direction (refers to a direction orthogonal to an observation surface; hereinafter, the same applies in this paragraph) is observed as a dark portion in the cross-sectional SEM image. A region where the orientation of the optical axis 40A is orthogonal (including a position substantially orthogonal) to the observation direction is observed as a bright portion in the cross-sectional SEM image.

Accordingly, as shown in FIG. 4, in a case where the X-Z plane of the cholesteric liquid crystal layer 10a is observed with a scanning electron microscope (SEM), bright portions 42 and dark portions 44 are alternately arranged, and a stripe pattern where the bright portions 42 and the dark portions 44 are tilted at a predetermined angle β with respect to the main surface (X-Y plane) is observed. In FIG. 4, two bright portions 42 and two dark portions 44 correspond to one helical pitch (one helical turn).

As shown in FIG. 3, the liquid crystal compounds 40 observed on the main surface of the cholesteric liquid crystal layer 10a are arranged along one direction (that is, one direction of an arrangement axis D₁) among in-plane directions of the cholesteric liquid crystal layer 10a. On each of the arrangement axes D₁, the orientation of the optical axis 40A of the liquid crystal compound 40 changes while continuously rotating in the one in-plane direction along the arrangement axis D₁. Here, for the convenience of description, it is assumed that the arrangement axis D₁ is directed to the X direction. In addition, in the Y direction, the liquid crystal compounds 40 in which the orientations of the optical axes 40A are the same are aligned at regular intervals.

Specifically, “the orientation of the optical axis 40A of the liquid crystal compound 40 changes while continuously rotating in the arrangement axis D₁ direction represents that an angle between the optical axis 40A of the liquid crystal compound 40, which is arranged in the arrangement axis D₁ direction, and the arrangement axis D₁ direction varies depending on positions in the arrangement axis D₁ direction, and the angle between the optical axis 40A and the arrangement axis D₁ direction sequentially changes from θ to 0+180° or θ−180° in the arrangement axis D₁ direction.

A difference between the angles of the optical axes 40A of the liquid crystal compounds 40 adjacent to each other in the arrangement axis D₁ direction is preferably 45° or less, more preferably 15° or less, and still more preferably less than 15°.

In addition, in the present invention, the liquid crystal compound rotates in the orientation in which an angle between the optical axes 40A of the liquid crystal compounds 40 adjacent to each other in the arrangement axis D₁ direction decreases. Accordingly, in the cholesteric liquid crystal layer 10a shown in FIG. 3, the optical axis 40A of the liquid crystal compound 40 rotates to the left (counterclockwise) in the direction indicated by the arrow of the arrangement axis D₁.

On the other hand, in the liquid crystal compound 40 forming the cholesteric liquid crystal layer 10a, the orientations of the optical axes 40A are the same in the Y direction orthogonal to the arrangement axis D₁ direction, that is, the Y direction orthogonal to the one direction in which the optical axis 40A continuously rotates. In other words, in the liquid crystal compound 40 forming the cholesteric liquid crystal layer 10a, angles between the optical axes 40A of the liquid crystal compound 40 and the arrangement axis D₁ direction are the same in the Y direction.

In the cholesteric liquid crystal layer, a surface along the bright portion and the dark portion substantially matches with a reflecting surface. Therefore, in the present invention, the cholesteric liquid crystal layer 10a includes the reflecting surface tilted with respect to the main surface of the cholesteric liquid crystal layer 10a. Accordingly, in the display system 100 for rear projection according to the embodiment of the present invention, light incident into the transparent screen 102 (cholesteric liquid crystal layer 10a) is reflected from the reflecting surface of the cholesteric liquid crystal layer 10a by specular reflection and is reflected from the main surface of the transparent screen 102 by non-specular reflection where an incidence angle and a reflection angle are different. Accordingly, the transparent screen 102 including the above-described cholesteric liquid crystal layer 10a as the light projection layer can emit light incident from an oblique direction into the rear surface of the transparent screen 102 in the front direction (direction perpendicular to the main surface) of the front side.

Here, it is preferable that the bright portions 42 and the dark portions 44 of the cholesteric liquid crystal layer 10a are tilted at 20° to 90° with respect to the main surface of the cholesteric liquid crystal layer 10a. That is, in FIG. 4, the angle β is preferably 20° to 90°, more preferably 35° to 87.5°, and still more preferably 40° to 85°. By adjusting the angle β to be in the above-described range, even in a case where the angle θ₁ between the ray projected on the point that is positioned on the video light emitted from the projection device 110 and is closest to the projection opening 110a and the normal line of the transparent screen 102 (hereinafter, also referred to as “the angle θ₁ between the ray of the video light and the normal line of the transparent screen” or “the angle θ₁”) is 30° or more, light incident from an oblique direction into the rear surface 103 of the transparent screen 102 can be appropriately emitted in the front direction (direction perpendicular to the main surface) of the front surface 104 side.

In a case where the above-described cholesteric liquid crystal layer 10a is used as the light projection layer 10, light incident from an oblique direction into the rear surface of the transparent screen 102 can be appropriately emitted in the front direction of the front side to improve the video visibility, and the amount of linearly transmitted light can be reduced. Therefore, the angle θ₁ between the ray of the video light and the normal line of the transparent screen is preferably 30° to 60° and more preferably 35° to 60°.

In addition, in a case where the above-described cholesteric liquid crystal layer 10a is used as the light projection layer 10, a large amount of light incident from an oblique direction into the rear surface of the transparent screen 102 can be emitted in the front direction of the front side as compared to a case of a light scattering layer 10b described below. Therefore, the cholesteric liquid crystal layer 10a can be made thinner than the light scattering layer 10b, and the transparency can be further improved.

In a case where the above-described cholesteric liquid crystal layer 10a is used as the light projection layer 10, the transparent screen 102 may include one cholesteric liquid crystal layer 10a or may include a plurality of cholesteric liquid crystal layers 10a having different selective reflection wavelengths. For example, in a case where the projection device emits a RGB color image, a configuration where a cholesteric liquid crystal layer that selectively reflects red light, a cholesteric liquid crystal layer that selectively reflects green light, and a cholesteric liquid crystal layer that selectively reflects blue light are provided as the light projection layer 10 may be adopted. Alternatively, as the cholesteric liquid crystal layer, a cholesteric liquid crystal layer where the helical pitch changes in a thickness direction to have a broad reflection wavelength range may be used.

In addition, in a case where the above-described cholesteric liquid crystal layer 10a is used as the light projection layer 10, the transparent screen 102 may include a plurality of cholesteric liquid crystal layers 10a having different circularly polarized light selectivities. That is, a cholesteric liquid crystal layer that selectively reflects right circularly polarized light and a cholesteric liquid crystal layer that selectively reflects left circularly polarized light may be provided. For example, a configuration where a cholesteric liquid crystal layer that selectively reflects right circularly polarized light of red light, a cholesteric liquid crystal layer that selectively reflects left circularly polarized light of red light, a cholesteric liquid crystal layer that selectively reflects right circularly polarized light of green light, a cholesteric liquid crystal layer that selectively reflects left circularly polarized light of green light, a cholesteric liquid crystal layer that selectively reflects right circularly polarized light of blue light, and a cholesteric liquid crystal layer that selectively reflects left circularly polarized light of blue light are provided may be adopted.

In addition, in a case where the above-described cholesteric liquid crystal layer 10a is used as the light projection layer 10, the transparent screen 102 may include an alignment film between the support 106 and the cholesteric liquid crystal layer 10a. The alignment film will be described below.

Next, a method of manufacturing the cholesteric liquid crystal layer 10a will be described.

The method of manufacturing the cholesteric liquid crystal layer according to the embodiment of the present invention is not limited as long as it is a method capable of manufacturing the cholesteric liquid crystal layer where the bright portions and the dark portions observed in the cross-sectional SEM image perpendicular to the main surface of the cholesteric liquid crystal layer are tilted with respect to the normal direction of the main surface of the cholesteric liquid crystal layer. Hereinafter, a preferable method of manufacturing the cholesteric liquid crystal layer including the transparent screen according to the embodiment of the present invention will be described.

It is preferable that the above-described method of manufacturing the cholesteric liquid crystal layer includes: a step (hereinafter, also referred to as “step (A)”) of applying a composition including a liquid crystal compound and a chiral agent to a support (temporary support); and a step (hereinafter, also referred to as “step (B)”) of applying a shearing force to a surface of the composition applied to the support. Through the step (A) and the step (B), the cholesteric liquid crystal layer can be formed on the support. In the step (B), by applying a shearing force to the composition including the liquid crystal compound and the chiral agent, the cholesteric liquid crystal layer where the bright portions and the dark portions observed in the cross-sectional SEM image are tilted with respect to the normal direction of the main surface of the cholesteric liquid crystal layer can be formed. In addition, by repeating the step (A) and the step (B), a plurality of cholesteric liquid crystal layers can be formed on the support. Hereinafter, each step will be specifically described.

### (Step (A))

In the step (A), the composition including the liquid crystal compound and the chiral agent is applied to the support.

“Applying the composition to the support” is not limited to a case where the composition is brought into direct contact with the support and includes a case where the composition is brought into contact with the support with any layer interposed therebetween. Any layer may be one component of the support or may be a layer that is formed on the support before the application of the composition. Examples of any layer include an alignment film for aligning the liquid crystal compound. A method of forming the alignment film will be described.

### -Support-

Examples of the support used in the step (A) include the support described above in “Support”. A preferable aspect of the support used in the step (A) is the same as that of the support described above in “Support”. The alignment film may be disposed in advance on the surface of the support used in the step (A).

### -Liquid Crystal Compound-

As the liquid crystal compound in the composition, for example, a well-known liquid crystal compound that forms a cholesteric liquid crystal can be used. The composition may include one kind of liquid crystal compound alone or two or more kinds of liquid crystal compounds.

The liquid crystal compound may have a polymerizable group. The liquid crystal compound may have one kind of polymerizable group alone or two or more kinds of polymerizable groups. The liquid crystal compound may have two or more polymerizable groups of the same kind. The liquid crystal compound has a polymerizable group and thus is polymerizable. By polymerizing the liquid crystal compound, the stability of the cholesteric liquid crystal can be improved.

Examples of the polymerizable group include a group having an ethylenically unsaturated double bond, a cyclic ether group, and a nitrogen-containing heterocyclic group capable of inducing a ring-opening reaction.

Examples of the group having an ethylenically unsaturated double bond include an acryloyl group, a methacryloyl group, an acryloyloxy group, a methacryloyloxy group, a vinyl group, a vinylphenyl group, and an allyl group.

Examples of the cyclic ether group include an epoxy group and an oxetanyl group.

Examples of the nitrogen-containing heterocyclic group capable of inducing a ring-opening reaction include an aziridinyl group.

The polymerizable group is preferably at least one kind selected from the group consisting of a group having an ethylenically unsaturated double bond and a cyclic ether group. Specifically, the polymerizable group is preferably at least one kind selected from the group consisting of an acryloyl group, a methacryloyl group, an acryloyloxy group, a methacryloyloxy group, a vinyl group, a vinylphenyl group, an allyl group, an epoxy group, an oxetanyl group, and an aziridinyl group, more preferably at least one kind selected from the group consisting of an acryloyl group, a methacryloyl group, an acryloyloxy group, and a methacryloyloxy group, and still more preferably at least one kind selected from the group consisting of an acryloyloxy group and a methacryloyloxy group.

The liquid crystal compound is classified into, for example, a rod-like liquid crystal compound and a disk-like liquid crystal compound depending on the chemical structure. The rod-like liquid crystal compound is known as a liquid crystal compound having a rod-like chemical structure. As the rod-like liquid crystal compound, for example, a well-known rod-like liquid crystal compound can be used. The disk-like liquid crystal compound is known as a liquid crystal compound having a disk-like chemical structure. As the disk-like liquid crystal compound, for example, a well-known disk-like liquid crystal compound can be used.

From the viewpoint of adjusting the optical characteristics (particularly the diffraction characteristics of light) of the cholesteric liquid crystal layer, the liquid crystal compound is preferably a rod-like liquid crystal compound and more preferably a rod-like thermotropic liquid crystal compound.

The rod-like thermotropic liquid crystal compound is a compound having a rod-like chemical structure and exhibiting liquid crystallinity in a specific temperature range. As the rod-like thermotropic liquid crystal compound, for example, a well-known rod-like thermotropic liquid crystal compound can be used.

Specific examples of the rod-like thermotropic liquid crystal compound include compounds described in Makromol. Chem. (1989), Vol. 190, p. 2255, Advanced Materials (1993), Vol. 5, p. 107, U.S. Pat. Nos. 4,683,327A, 5,622,648A, 5,770,107A, WO95/22586, WO95/24455,WO97/00600, WO98/23580, WO98/52905, JP1989-272551A (JP-H1-272551A), JP1994-16616A (JP-H6-16616A), JP1995-110469A (JP-H7-110469A), JP1999-513019A (JP-H11-513019A), JP1999-80081A (JP-H11-80081A), JP2001-328973A, and JP2007-279688A. Examples of the rod-like thermotropic liquid crystal compound include a liquid crystal compound represented by Formula 1 in JP2016-81035A and a compound represented by Formula (I) or Formula (II) in JP2007-279688A.

The rod-like thermotropic liquid crystal compound is preferably a compound represented by Formula (1).

Q¹—L¹—A¹—L³—M—L⁴—A²—L²—Q² (1)

In Formula (1), Q¹ and Q² each independently represent a polymerizable group, L¹, L², L³, and L⁴ each independently represent a single bond or a divalent linking group, A¹ and A² each independently represent a divalent hydrocarbon group having 2 to 20 carbon atoms, and M represents a mesogen group.

In Formula (1), examples of the polymerizable group represented by Q¹ and Q² include the above-described polymerizable group. A preferable aspect of the polymerizable group represented by Q¹ and Q² are the same as those of the above-described polymerizable group.

In Formula (1), the divalent linking group represented by each of L¹, L², L³, and L⁴ is preferably a divalent linking group selected from the group consisting of —O—, —S—, —CO—, —NR—, —CO—O—, —O—CO—O—, —CO—NR—, —NR—CO—, —O—CO—, —O—CO—NR—, —NR—CO—O—, and NR—CO—NR—. R in the above-described divalent linking group represents an alkyl group having 1 to 7 carbon atoms or a hydrogen atom.

In Formula (1), it is preferable that at least one of L³ or L⁴ represents —O—CO—O—.

In Formula (1), Q¹—L¹— and Q²—L²— each independently represent preferably CH₂═CH—CO—O—, CH₂═C(CH₃)—CO—O—, or CH₂═C (Cl)—CO—O—, and more preferably CH₂═CH—CO—O—.

The divalent hydrocarbon group having 2 to 20 carbon atoms represented by each of A¹ and A² in Formula (1) is preferably an alkylene group having 2 to 12 carbon atoms, an alkenylene group having 2 to 12 carbon atoms, or an alkynylene group having 2 to 12 carbon atoms, and more preferably an alkylene group having 2 to 12 carbon atoms. The divalent hydrocarbon group is preferably chainlike. The divalent hydrocarbon group may include oxygen atoms not adjacent to each other or may include sulfur atoms not adjacent to each other. The divalent hydrocarbon group may have a substituent. Examples of the substituent include a halogen atom (for example, fluorine, chlorine, and bromine), a cyano group, a methyl group, and an ethyl group.

The mesogen group represented by M in Formula (1) is a group representing a main skeleton of the liquid crystal compound which contributes to liquid crystal formation. The mesogen group represented by M is not particularly limited, and the details can be found in, for example, “Flussigkristalle in Tabellen II” (in particular, pp. 7 to 16) (VEB Deutscher Verlag fur Grundstoff Industrie, Leipzig, 1984) and “Liquid crystal Handbook” (in particular, Chapter 3) (edited by Liquid Crystal Handbook Editing Committee, Maruzen, 2000).

In Formula (1), examples of a specific structure of the mesogen group represented by M include structures described in paragraph “0086” of JP2007-279688A.

In Formula (1), the mesogen group represented by M is preferably a group having at least one cyclic structure selected from the group consisting of an aromatic hydrocarbon group, a heterocyclic group, and an alicyclic hydrocarbon group, and more preferably a group having an aromatic hydrocarbon group.

In Formula (1), the mesogen group represented by M is preferably a group having 2 to 5 aromatic hydrocarbon groups, and more preferably a group having 3 to 5 aromatic hydrocarbon groups.

In Formula (1), the mesogen group represented by M is preferably a group having 3 to 5 phenylene groups in which the phenylene groups are linked to each other through —CO—O—.

In Formula (1), the cyclic structure (for example, an aromatic hydrocarbon group, a heterocyclic group, and an alicyclic hydrocarbon group) in the mesogen group represented by M may have a substituent. Examples of the substituent include an alkyl group (for example, a methyl group) having 1 to 10 carbon atoms.

Specific examples of the compound represented by Formula (1) are as follows. Here, the compound represented by Formula (1) is not limited to the compounds shown below. In the chemical structure of the compounds shown below, “—Me” represents a methyl group.

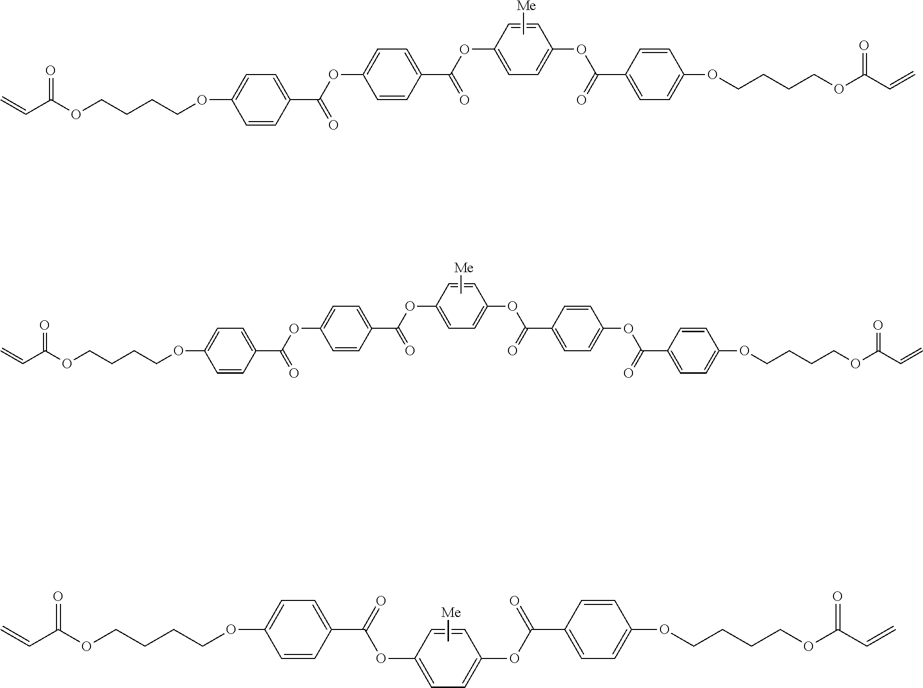

Specific examples of the rod-like thermotropic liquid crystal compound are shown below. Here, the rod-like thermotropic liquid crystal compound is not limited to the compounds shown below.

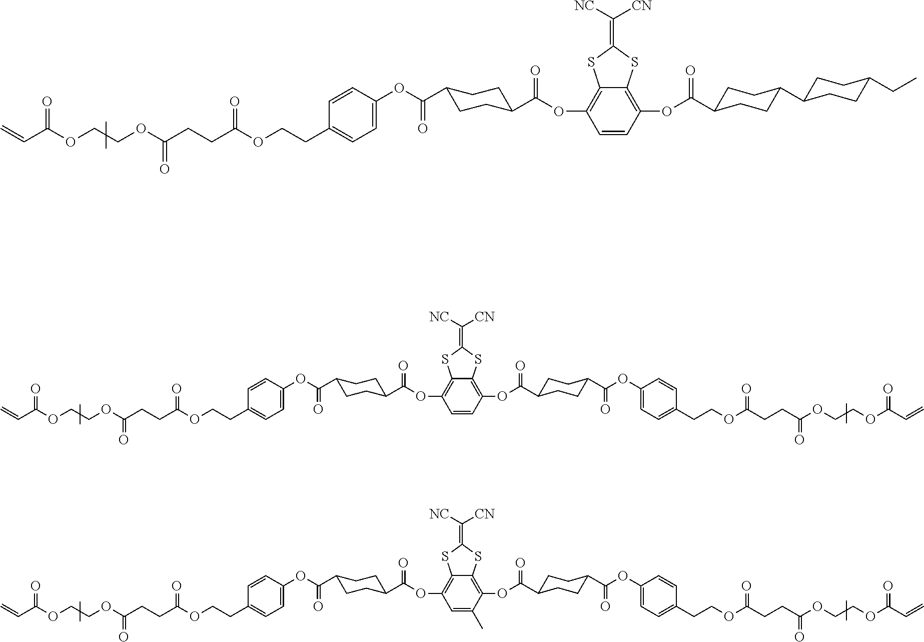

The liquid crystal compound may be a synthetic product synthesized using a well-known method or a commercially available product. The commercially available product of the liquid crystal compound is available from, for example, Tokyo Chemical Industry Co., Ltd. and Merck KGaA.

From the viewpoint of heat resistance, a content of the liquid crystal compound is preferably 70 mass % or more, more preferably 80 mass % or more, and still more preferably 90 mass % or more with respect to the total mass of the cholesteric liquid crystal layer. The upper limit of the content of the liquid crystal compound is not limited. The content of the liquid crystal compound may be determined in a range of 100 mass % or less with respect to the total mass of the cholesteric liquid crystal layer. In a case where the cholesteric liquid crystal layer includes components other than the liquid crystal compound, the content of the liquid crystal compound may be determined in a range of less than 100 mass % (preferably 98 mass % or less, or 95 mass % or less) with respect to the total mass of the cholesteric liquid crystal layer. The content of the liquid crystal compound is preferably 70 mass % or more and less than 100 mass %, more preferably 80 mass % or more and less than 100 mass %, and still more preferably 90 mass % or more and less than 100 mass % with respect to the total mass of the cholesteric liquid crystal layer.

The content of the liquid crystal compound in the composition is preferably 70 mass % or more, more preferably 80 mass % or more, and still more preferably 90 mass % or more with respect to the solid content mass of the composition. The upper limit of the content of the liquid crystal compound may be determined depending on the content of the components other than the liquid crystal compound. The content of the liquid crystal compound may be determined in a range of less than 100 mass % (preferably 98 mass % or less, or 95 mass % or less) with respect to the solid content mass of the composition.

### -Chiral Agent-

The composition for forming the cholesteric liquid crystal layer includes a chiral agent.

The kind of the chiral agent is not limited. As the chiral agent, for example, well-known chiral agents (for example, “Liquid Crystal Device Handbook, Chapter 3, Section 4-3, TN, chiral agent for STN, p. 199, edited by Japan Society for the Promotion of Science, 142nd Committee, 1989)” can be used.

Most of the chiral agents include a chiral carbon atom. Here, the chiral agent is not limited to a compound having a chiral carbon atom. Examples of the chiral agent also include an axially chiral compound not having a chiral carbon atom and a planar chiral compound. Examples of the axially chiral compound or the planar chiral compound include binaphthyl, helicene, paracyclophane, and a derivative thereof.

The chiral agent may have a polymerizable group. For example, a polymer including a constitutional unit derived from the chiral agent and a constitutional unit derived from the liquid crystal compound can be obtained by a reaction between the chiral agent having a polymerizable group and the liquid crystal compound having a polymerizable group.

Examples of the polymerizable group in the chiral agent include the polymerizable groups described above in “Liquid Crystal Compound”. A preferable aspect of the polymerizable group in the chiral agent is the same as that of the polymerizable group described above in “Liquid Crystal Compound”. It is preferable that the kind of the polymerizable group in the chiral agent is the same as the kind of the polymerizable group in the liquid crystal compound.

Examples of the chiral agent exhibiting a strong twisting power include the chiral agents described in JP2010-181852A, JP2003-287623A, JP2002-080851A, JP2002-080478A, and JP2002-302487A. Regarding isosorbide compounds described in the above-mentioned documents, isomannide compounds having corresponding structures can also be used as the chiral agent. Regarding the isomannide compounds described in the above-mentioned documents, isosorbide compounds having corresponding structures can also be used as the chiral agent.

The content of the chiral agent is preferably 0.1 mass % to 20.0 mass %, more preferably 0.2 mass % to 15.0 mass %, and still more preferably 0.5 mass % to 10.0 mass % with respect to the solid content mass of the composition.

### -Other Components-

The composition may include components other than the above-described components (hereinafter also referred to as “other components”). Examples of the other components include a solvent, an alignment restriction agent, a polymerization initiator, a leveling agent, an alignment assistant, and a sensitizer.

As the solvent, an organic solvent is preferable. Examples of the organic solvent include an amide solvent (for example, N,N-dimethylformamide), a sulfoxide solvent (for example, dimethyl sulfoxide), a heterocyclic compound (for example, pyridine), a hydrocarbon solvent (for example, benzene or hexane), an alkyl halide solvent (for example, chloroform or dichloromethane), an ester solvent (for example, methyl acetate or butyl acetate), a ketone solvent (for example, acetone, methyl ethyl ketone, or cyclohexanone), and an ether solvent (for example, tetrahydrofuran or 1,2-dimethoxyethane). The organic solvent is preferably at least one selected from the group consisting of an alkyl halide solvent and a ketone solvent, and more preferably a ketone solvent.

The composition may include one kind of solvent alone or two or more kinds of solvents.

The content of the solid content in the composition is preferably 25 mass % to 40 mass % and more preferably 25 mass % to 35 mass % with respect to the total mass of the composition.

Examples of the alignment restriction agent include compounds described in paragraphs “0012” to “0030” of JP2012-211306A, compounds described in paragraphs “0037” to “0044” of JP2012-101999A, fluorine-containing (meth)acrylate polymers described in paragraphs “0018” to “0043” of JP2007-272185A, and compounds described in detail together with a synthesis method in JP2005-099258A. A polymer including more than 50 mass % of a polymerization unit of a fluoroaliphatic group-containing monomer described in JP2004-331812A with respect to all the polymerization units may be used as the alignment restriction agent.

Examples of the alignment restriction agent include a vertical alignment agent. Examples of the vertical alignment agent include a boronic acid compound and/or an onium salt described in JP2015-38598A and an onium salt described in JP2008-26730A.

In a case where the composition includes the alignment restriction agent, the content of the alignment restriction agent is preferably more than 0 mass % and 5.0 mass % or less, and more preferably 0.3 mass % to 2.0 mass % with respect to the solid content mass of the composition.

Examples of the polymerization initiator include a photopolymerization initiator and a thermal polymerization initiator.

From the viewpoint of suppressing deformation of the support due to heat and degeneration of the composition, the polymerization initiator is preferably a photopolymerization initiator. Examples of the photopolymerization initiator include an α-carbonyl compound (for example, a compound described in U.S. Pat. Nos. 2,367,661A or 2,367,670A), an acyloin ether (for example, a compound described in U.S. Pat. No. 2,448,828A), an α-hydrocarbon-substituted aromatic acyloin compound (for example, a compound described in U.S. Pat. No. 2,722,512A), a polynuclear quinone compound (for example, a compound described in U.S. Pat. No. 3,046,127A or U.S. Pat. No. 2,951,758A), a combination of a triarylimidazole dimer and p-aminophenyl ketone (for example, a compound described in U.S. Pat. No. 3,549,367A), an acridine compound (for example, a compound described in JP1985-105667A (JP-S60-105667A) or U.S. Pat. No. 4,239,850A), a phenazine compound (for example, a compound described in JP1985-105667A (JP-S60-105667A) or U.S. Pat. No. 4,239,850A), an oxadiazole compound (for example, a compound described in U.S. Pat. No. 4,212,970A), and an acylphosphine oxide compound (for example, a compound described in JP1988-40799B (JP-S63-40799B), JP1993-29234B (JP-H5-29234B), JP1998-95788A (JP-H10-95788A), or JP1998-29997A (JP-H10-29997A)).

In a case where the composition includes a polymerization initiator, the content of the polymerization initiator is preferably 0.5 mass % to 5.0 mass % and more preferably 1.0 mass % to 4.0 mass % with respect to the solid content mass of the composition.

### -Method of Manufacturing Composition-

A method of manufacturing the composition is not limited. Examples of the method of manufacturing the composition include a method of mixing the above-described components. As a mixing method, a well-known mixing method can be used. In the method of manufacturing the composition, after mixing the above-described components, and the obtained mixture may be filtered.

### -Application Method-

A method of applying the composition is not limited. Examples of the method of applying the composition include an extrusion die coater method, a curtain coating method, a dip coating method, a spin coating method, a printing coating method, a spray coating method, a slot coating method, a roll coating method, a slide coating method, a blade coating method, a gravure coating method, and a wire bar coating method.

### -Application Amount-

The application amount of the composition is not limited. The application amount of the composition may be determined depending on the desired thickness of the cholesteric liquid crystal layer or the thickness of the composition before application of a shearing force described below in “Step (B)”.

### (Step (B))

In the step (B), a shearing force is applied to the surface of the applied composition.

### -Means for Applying Shearing Force-

Examples of means for applying the shearing force include a blade, an air knife, a bar, and an applicator. In the step (B), it is preferable that a shearing force is applied to the surface of the composition using a blade or an air knife, and it is more preferable that a shearing force is applied to the surface of the composition using a blade.

In the method of applying a shearing force to the surface of the composition using a blade, it is preferable to scrape the surface of the composition with the blade. In the above-described method, the thickness of the composition may change before and after applying the shearing force. The thickness of the composition after applying the shearing force with the blade may be ½ or less or ⅓ or less with respect to the thickness of the composition before applying the shearing force. The thickness of the composition after applying the shearing force with the blade is preferably ¼ or more with respect to the thickness of the composition before applying the shearing force.

A material of the blade is not limited. Examples of the material of the blade include a metal (for example, stainless steel) and a resin (for example, Teflon (registered trade name) and polyether ether ketone (PEEK)).

A shape of the blade is not limited. Example of the blade include a plate shape.

From the viewpoint of easily applying a shearing force to the composition, the blade is preferably a metal plate-shaped member.

From the viewpoint of easily applying a shearing force to the composition, the thickness of a tip part of the blade coming into contact with the composition is preferably 0.1 mm or more and more preferably 1 mm or more. The upper limit of the thickness of the blade is not limited. The thickness of the blade may be determined, for example, in a range of 10 mm or less.

In the method of applying a shearing force to the surface of the composition using an air knife, the shearing force is applied to the surface of the composition by blowing compressed air to the surface of the composition using the air knife. The shear rate during the application to the composition can be adjusted depending on a speed (a flow rate) at which the compressed air is blown.

A blowing direction of the compressed air by the air knife may be the same as or opposite to a transport direction of the composition. From the viewpoint of preventing fragments of the composition scraped off by the compressed air from adhering to the composition remaining on the support, it is preferable that the blowing direction of the compressed air by the air knife is the same as the transport direction of the composition.

### -Shear Rate-

As the shear rate in the step (B) increases, a cholesteric liquid crystal layer having a high alignment accuracy can be formed. The shear rate is preferably 1,000 sec⁻¹ or more, more preferably 10,000 sec⁻¹ or more, and still more preferably 30,000 sec⁻¹ or more. The upper limit of the shear rate is not limited. The shear rate may be determined, for example, in a range of 1.0×10⁶ sec⁻¹ or less.

Hereinafter, a method of obtaining the shear rate will be described. For example, in a case where a shearing force is applied using a blade, that the shear rate is obtained from “V/d”, where “d” represents the shortest distance between the blade and the support and “V” represents the transportation speed of the composition coming into contact with the blade (that is, a relative speed between the composition and the blade). In addition, for example, in a case where a shearing force is applied using an air knife, that the shear rate is obtained from “V/2h”, where “h” represents the thickness of the composition after applying the shearing force and “V” represents a relative speed between the surface of the composition and the surface of the support.

### -Surface Temperature of Composition-

A surface temperature of the composition during the application of the shearing force may be determined depending on a phase transition temperature of the liquid crystal compound in the composition. The surface temperature of the composition during the application of the shearing force is preferably 50° C. to 120° C. and more preferably 60° C. to 100° C. By adjusting the surface temperature of the composition to be in the above-described range, a cholesteric liquid crystal layer having a high alignment accuracy can be obtained. The surface temperature of the composition is measured using a radiation thermometer where an emissivity is calibrated based on a temperature value measured by a non-contact thermometer. The surface temperature of the composition is measured in a state where there is no reflector within a 10 cm from a surface (that is, the rear side) opposite to a measurement surface.

### -Thickness of Composition-

From the viewpoint of forming a cholesteric liquid crystal layer having a high alignment accuracy, the thickness of the composition before applying the shearing force is preferably in a range of 30 μm or less and more preferably in a range of 15 μm to 25 μm.

From the viewpoint of forming a cholesteric liquid crystal layer having a high alignment accuracy, the thickness of the composition after applying the shearing force is preferably in a range of 10 μm or less and more preferably in a range of 7 μm or less. The lower limit of the thickness of the composition after applying the shearing force is not limited. The thickness of the composition after applying the shearing force is preferably in a range of 5 μm or more.

### (Step (C))

In a case where the composition includes a solvent, it is preferable that the method of manufacturing a cholesteric liquid crystal layer includes a step (hereinafter, also referred to as a “step (C)”) of adjusting the content of the solvent in the applied composition to be in a range of 50 mass % or less with respect to the total mass of the composition between the step (A) and the step (B). By adjusting the content of the solvent in the composition to be in a range of 50 mass % or less, a cholesteric liquid crystal layer having a high alignment accuracy can be formed.

In the step (C), the content of the solvent in the composition is preferably 40 mass % or less and more preferably 30 mass % or less with respect to the total mass of the composition. The lower limit of the content of the solvent in the applied composition is not limited. The content of the solvent in the applied composition may be 0 mass % or may exceed 0 mass % with respect to the total mass of the composition. From the viewpoint of easily suppressing deterioration of the surface state of the applied composition, the content of the solvent in the applied composition is preferably 10 mass % or more.

The content of the solvent in the composition is measured using an absolute dry method. Hereinafter, a specific procedure of the measuring method will be described. After drying a sample collected from the composition at 60° C. for 24 hours, a mass change of the sample before and after drying (that is, a difference between the mass of the sample after drying and the mass of the sample before drying) is obtained. The content of the solvent in the sample is determined based on the mass change of the sample before and after drying. The arithmetic mean of values obtained by performing the above-described operation three times is obtained as the content of the solvent.

Examples of the method adjusting the content of the solvent in the applied composition in the step (C) include drying.

As drying means of the composition, well-known drying means can be used. Examples of the drying means include an oven, a hot air blower, and an infrared (IR) heater.

During drying using a hot air blower, hot air may be directly blown to the composition, or hot air may be blown to a surface of the support opposite to the surface on which the composition is disposed. In addition, in order to suppress the flowing of the surface of the composition by hot air, a diffusion plate may be provided.

Drying may be performed by air suction. For the drying by air suction, for example, a decompression chamber using an evacuation mechanism can be used. By suctioning gas around the composition, the content of the solvent in the composition can be reduced.

Drying conditions are not limited as long as the content of the solvent in the composition can be adjusted to be in a range of 50 mass % or less. The drying conditions may be determined depending on, for example, the components in the composition, the application amount of the composition, and the transportation speed.

### (Step (D))

In a case where the composition includes a polymerizable compound (for example, a liquid crystal compound having a polymerizable group or a chiral agent having a polymerizable group), it is preferable that the method of manufacturing the cholesteric liquid crystal layer includes a step (hereinafter, referred to as “step (D)”) of curing the composition to which the shearing force is applied after the step (B). By curing the composition in the step (D), the molecular arrangement of the liquid crystal compound can be immobilized.

Examples of a method of curing the composition include heating and irradiation of an active energy ray. In the step (D), from the viewpoint of manufacturing suitability, it is preferable that the composition is cured by irradiating the composition to which the shearing force is applied with an active energy rays.

Examples of the active energy ray include α-rays, γ rays, X-rays, ultraviolet rays, infrared rays, visible rays, and electron beams. The active energy ray is preferably an ultraviolet ray from the viewpoints of curing sensitivity and easy availability of the device.

Examples of a light source of an ultraviolet ray include commonly used light sources, for example, lamps (for example, a tungsten lamp, a halogen lamp, a xenon lamp, a xenon flash lamp, a mercury lamp, a mercury-xenon lamp, and a carbon arc lamp), lasers (for example, a semiconductor laser, a helium a neon laser, an argon ion laser, a helium cadmium laser, and a yttrium aluminum garnet (YAG) laser), light emitting diodes, and a cathode ray tube.

A peak wavelength of the ultraviolet rays emitted from the light source of an ultraviolet ray is preferably 200 nm to 400 nm.

An exposure amount (also referred to as a cumulative light amount) of the ultraviolet rays is preferably 100 mJ/cm² to 500 mJ/cm².

### (Other Steps)

The method of manufacturing the cholesteric liquid crystal layer may include steps other than the above-described steps. The method of manufacturing the cholesteric liquid crystal layer may include, for example, a step of forming an alignment film on the support. It is preferable that the step of forming the alignment film on the support is performed before the step (A).

Examples of the method of forming the alignment film include a rubbing treatment of an organic compound (preferably a polymer), oblique vapor deposition of an inorganic compound, and formation of a layer having a microgroove.

### -Alignment Film-

The alignment film is not limited as long as it applies an alignment restriction force to the liquid crystal compound.

It is preferable that the alignment film is disposed between the substrate and the cholesteric liquid crystal layer.

As the alignment film, for example, a well-known alignment film having a function of applying an alignment restriction force to the liquid crystal compound can be used. Furthermore, the alignment film may be an alignment film in which an alignment function is provided by application of an electric field, application of a magnetic field, or light irradiation.

The thickness of the alignment film is preferably in a range of 0.1 μm to 10 μm, and more preferably in a range of 1 μm to 5 μm.

### (Manufacturing Method)

The method of manufacturing the cholesteric liquid crystal layer may be performed using a roll-to-roll method. In the roll-to-roll method, for example, each of the steps is performed while continuously transporting the elongated support. The method of manufacturing the cholesteric liquid crystal layer may be performed using the support that is being transported one by one.

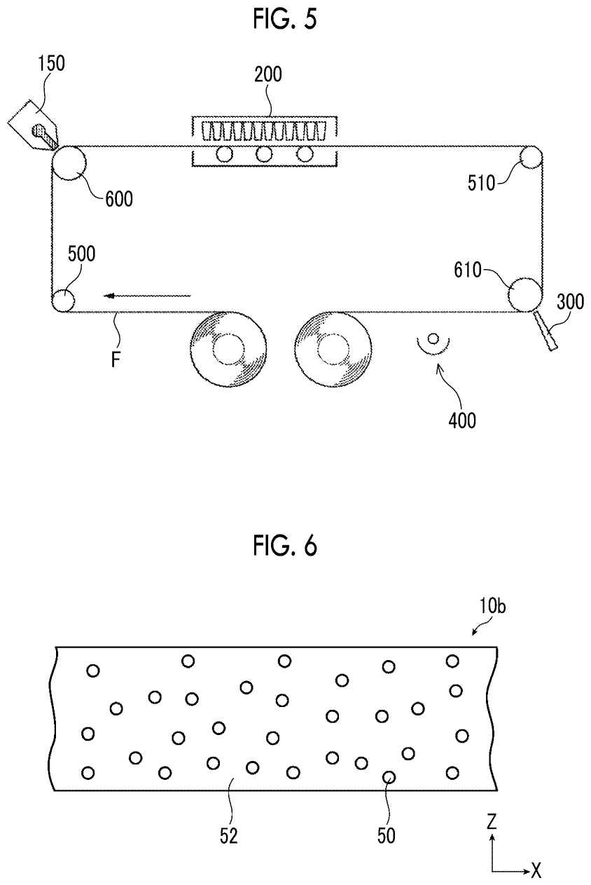

The method of manufacturing the cholesteric liquid crystal layer will be described with reference to FIG. 5. FIG. 5 is a schematic diagram showing an example of the method of manufacturing the cholesteric liquid crystal layer.

In FIG. 5, the cholesteric liquid crystal layer is manufactured using the roll-to-roll method. An elongated support F that is wound in a roll shape is transported in a direction of an arrow by a transport roll 500. A transportation speed of the support F is preferably 10 m/min to 100 m/min.

A composition is applied to the support F having passed through the transport roll 500 by an application device 150 (step (A)). The above-described composition includes a liquid crystal compound, a chiral agent, and a solvent. It is preferable that the application of the composition by the application device 150 is performed in a region where the support F is wound around a backup roll 600. Hereinafter, a preferable aspect of the backup roll 600 will be described.

The surface of the backup roll 600 may be plated with hard chromium. The thickness of the plating is preferably 40 μm to 60 μm.

A surface roughness Ra of the backup roll 600 is preferably 0.1 μm or less.

A surface temperature of the backup roll 600 may be controlled to be in any temperature range by temperature control means. The surface temperature of the backup roll 600 may be determined depending on the composition, curing properties of the composition, and the heat resistance of the support. The surface temperature of the backup roll 600 is, for example, preferably 40° C. to 120° C. and more preferably 40° C. to 100° C. Examples of the temperature control means of the backup roll 600 include heating means and cooling means. Examples of the heating means include induction heating, water heating, and oil heating. Examples of the cooling means include cooling by cooling water.

The diameter of the backup roll 600 is preferably 100 mm to 1,000 mm, more preferably 100 mm to 800 mm, and particularly preferably 200 mm to 700 mm.

A wrap angle of the support F with respect to the backup roll 600 is preferably 60 degrees or more and more preferably 90 degrees or more. In addition, the upper limit of the wrap angle can be set to be, for example, 180 degrees. “The wrap angle” refers to an angle between the transport direction of the support in a case where the support comes into contact with the backup roll and the transport direction of the support in a case where the support is spaced from the backup roll.

After applying the composition to the support F using the application device 150, the composition is dried by a drying device 200 (step (C)). By drying the composition, the content of the solvent in the composition is adjusted.

After drying the composition using the drying device 200, an upper surface of the composition having passed through a transport roll 510 is scraped using a blade 300 to apply a shearing force to the surface of the composition (step (B)). The shearing force is applied along the transport direction of the composition (that is, the transport direction of the support). It is preferable that the application of the shearing force by the blade 300 is performed in a region where the support F is wound around a backup roll 610.

A preferable aspect of the backup roll 610 is the same as that of the backup roll 600. A surface temperature of the backup roll 610 is, for example, preferably 50° C. to 120° C. and more preferably 60°° C. to 100° C.

After applying the shearing force to the composition, the composition is irradiated with an active energy ray from a light source 400 to cure the composition (step (D)). By curing the composition, a cholesteric liquid crystal layer is formed.

The cholesteric liquid crystal layer is formed on the support F obtained through each of the above-described steps. In addition, in the method of manufacturing the cholesteric liquid crystal layer shown in FIG. 5, by using the support F including the alignment film, a laminate including the support F, the alignment film, and the cholesteric liquid crystal layer in this order can be manufactured.

The prepared cholesteric liquid crystal layer may be used as the transparent screen together with the support F (and the alignment film). Alternatively, the cholesteric liquid crystal layer may be peeled off from the support F and transferred to another support to be used as the transparent screen.

### <<Light Scattering Layer>>

FIG. 6 is a diagram conceptually showing the light scattering layer used as the light projection layer.

As shown in FIG. 6, the light scattering layer 10b used as the light projection layer is a layer including light scattering particles 50 in a resin as a base material 52. The light scattering layer 10b scatters incident light using a difference in refractive index between the base material 52 and the light scattering particles 50. The light scattering layer 10b can scatter the video light incident from an oblique direction into the rear surface to direct the video light in a direction substantially perpendicular to the surface.

As the light scattering layer 10b, various well-known light scattering layers used for the transparent screen can be used.

Here, the refractive index refers to a refractive index with respect to light having a wavelength of 589.3 nm.

As the light scattering particles, any of organic fine particles or inorganic fine particles may be used.

The organic fine particles in the light scattering layer can be widely selected from well-known particles in the related art, for example, an acrylic polymer, a multi-component copolymer such as a styrene-acrylic copolymer, a vinyl acetate-acrylic copolymer, a vinyl acetate polymer, an ethylene-vinyl acetate copolymer, a chlorinated polyolefin polymer, or an ethylene-vinyl acetate-acrylic copolymer, SBR, NBR, MBR, carboxylated SBR, carboxylated NBR, carboxylated MBR, polyvinyl chloride, polyvinylidene chloride, polyester, polyolefin, polyurethane, polymethacrylate, polytetrafluoroethylene, polymethyl methacrylate, polycarbonate, a polyvinyl acetal resin, a rosin ester resin, an episulfide resin, an epoxy resin, a silicone resin, a silicone-acrylic resin, a melamine resin., and the like. In addition, fine particles of a melamine resin, an acrylic resin, or the like of which surfaces are coated with inorganic fine particles such as silica can be used. In addition, for example, even in a case where composite particles including the organic fine particles and a small amount of the inorganic fine particles (the ratio of the inorganic fine particles is less than 50 mass %) are used, the composite particles can be substantially considered as organic fine particles and used. Into a monomer of the above-described polymer, a sulfur atom can be introduced for use to increase the refractive index or a fluorine substituent can be introduced for use to improve weather fastness or to decrease the refractive index.

As the inorganic fine particles in the light scattering layer, colloidal silica, precipitation process silica, gel process silica, vapor-phase process silica, alumina, hydrated alumina, rutile or anatase titanium oxide, zinc oxide, zinc sulfide, lead white, antimony oxides, zinc antimonate, lead titanate, potassium titanate, barium titanate, zirconium oxide, cerium oxide, hafnium oxide, tantalum pentoxide, niobium pentoxide, yttrium oxide, chromium oxide, tin oxide, molybdenum oxide, nanodiamond, antimony-doped tin oxide (ATO), indium tin oxide (ITO), an oxide glass such as silicate glass, phosphate glass, or borate glass, or a composite oxide, a composite sulfide, or the like thereof can also be widely used. In addition, regarding inorganic fine particles such as titanium oxide or zinc oxide having photocatalytic activity the inorganic fine particle surfaces can be very thinly coated with silica, alumina, zirconia, or the like for use. In addition, for example, even in a case where composite particles including the inorganic fine particles and a small amount of an organic polymer (the ratio of the organic fine particles is less than 50 mass %) are used, the composite particles can be substantially considered as inorganic fine particles and used.

In the present invention, the organic fine particles or the inorganic fine particles used as the light scattering particles can be used alone or as a mixture of plural kinds, and both of the organic fine particles and the inorganic fine particles can also be mixed and used.

The light diffusion performance of the light scattering particles according to the embodiment of the present invention is affected by a relative refractive index between the base material and the light scattering particles of the light scattering layer. Therefore, the refractive index of the light scattering particles is preferably 1.6 or more and more preferably 2.0 or more. As the light scattering particles having a high refractive index that are particularly preferably used, titanium oxide or zirconium oxide can be used. In order to adjust the transparency and/or the tone of the transparent screen, light scattering particles such as colloidal silica having a low refractive index may be used in combination with the light scattering particles having a high refractive index.

In addition, an average particle diameter of the light scattering particle is preferably 45 nm or more and 340 nm or less. When the average particle diameter of the light scattering particles is 45 nm or more and 340 nm or less, the light scattering performance and the transparency of the screen can be achieved at a high level.

It is preferable that a resin having high transparency is used as the base material of the light scattering layer. Specifically, polyethylene terephthalate, acryl, polyester, polycarbonate, triacetyl cellulose, a cyclic olefin polymer, or the like is used.

Alternatively, as the base material of the light scattering layer, a gelatin gel described in JP2019-174546A may be used.

In addition, from the viewpoint that the incident video light can be sufficiently scattered without deteriorating the transmittance, the content of the light scattering particles in the light scattering layer is preferably 50 mass % or less, more preferably 10 mass % to 40 mass %, and still more preferably 15 mass % to 30 mass %.

In a case where the light scattering layer 10b is used as the light projection layer 10, light incident from an oblique direction into the rear surface of the transparent screen 102 can be appropriately emitted in the front direction of the front side to improve the video visibility, and the amount of linearly transmitted light can be reduced. Therefore, the angle θ₁ between the ray of the video light and the normal line of the transparent screen is preferably 45° to 60° and more preferably 45° to 57.5°.

In the present invention, the transparent screen 102 may include a layer other than the support 106, the alignment film, and the light projection layer 10 described above. For example, the transparent screen 102 may include a louver film that allows transmission of only light incident at a predetermined incidence angle. The transparent screen 102 includes the louver film such that the amount of linearly transmitted light can be reduced and the visibility can be improved.

In the louver film, a light transmitting zone and a light shielding zone having a belt shape are alternately disposed such that transmission of light incident from a specific direction is allowed and transmission of light incident from directions other than the specific direction is shielded. As the louver film, various well-known louver films can be appropriately used.

### <Other Aspects of Display System for Rear Projection>

Based on the standing position state of the display system for rear projection, light of a projection image from the projection device may be emitted from a ceiling side or an overhead side to the rear surface of the transparent screen, may be emitted from a wall surface (side surface) side to the transparent screen, or may be emitted from a floor side.

As described above, the display system for rear projection can be used for uses where an image is displayed on a window glass of an automobile, a building, or the like as the transparent screen.

Hereinabove, the display system for rear projection according to the embodiment of the present invention has been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Preparation of Transparent Screen 1

### <Preparation of Coating Liquid for Alignment Film Layer>

In a state where a container containing pure water (96 parts by mass) was kept at 80° C., PVA-205 (4 parts by mass, manufactured by Kuraray Co., Ltd.) is mixed and stirred to prepare a coating liquid for an alignment film layer.

### <Preparation of Coating Liquid for Cholesteric Liquid Crystal Layer>

The following components were mixed to prepare a coating liquid for a cholesteric liquid crystal layer having the following composition.
Mixture 1 of the following liquid crystal compounds 100 parts by mass
The following dextrorotatory chiral agent LC-756 (manufactured by BASF SE) 1.2 parts by mass

| | | |
|---|---|---|
| IRGACURE 907 (manufactured by BASF SE) | 3 | parts by mass |
| The following alignment restriction agent | 0.5 | parts by mass |
| PM758 (manufactured by Nippon Kayaku Co., | 1 | part by mass |
| Ltd.) | | |
| Methyl ethyl ketone | 184 | parts by mass |
| Cyclohexanone | 31 | parts by mass |

Mixture 1 of Liquid Crystal Compounds

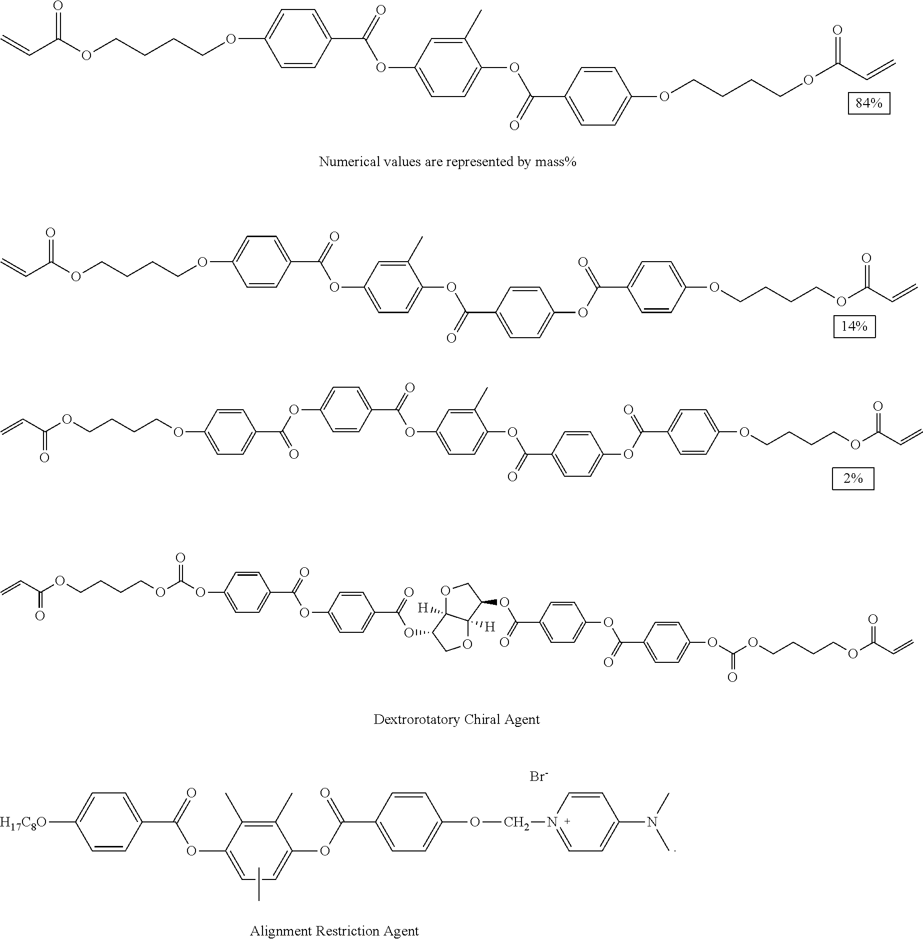

### <Formation of Alignment Film>

The coating liquid for an alignment film layer was applied to a triacetyl cellulose film (manufactured by Fujifilm Corporation, thickness: 80 μm) as a support using a No. 6 bar, and was subsequently dried at 100° C. for 10 minutes to form an alignment film having a thickness of 2 μm on the substrate.

### <Application of Coating Liquid for Cholesteric Liquid Crystal Layer)

Next, the support on which the above-described alignment film was formed was heated at 70° C., and the coating liquid for a cholesteric liquid crystal layer was applied to the alignment film using a No. 18 bar and was dried at 70° C. for 1 minute to form a cholesteric liquid crystal layer. In this case, the thickness of the cholesteric liquid crystal layer was 10 μm.

### <Application of Shearing Force>

Further, in a state where the above-described cholesteric liquid crystal layer was heated at 70° C., a stainless steel blade heated to 70° C. was brought into contact with the cholesteric liquid crystal layer. In this contact state, the blade was moved at a speed of 1.5 m/min to apply a shearing force. In this case, the shear rate was 2500 sec⁻¹.

### <Curing>

After the application of the shearing force, the cholesteric liquid crystal layer was irradiated (exposure amount: 500 mJ/cm²) with an ultraviolet ray using a metal halide lamp in a nitrogen atmosphere (oxygen concentration: less than 100 ppm). As a result, the above-described cholesteric liquid crystal layer was cured, and a transparent screen 1 was prepared.

<Tilt angle and Interval of Bright Portions and Dark Portions>

The transparent screen 1 prepared as described above was cut in a thickness direction, a cross-sectional image was observed with a SEM, and it was verified that the angle β between the bright portions and the dark portions and the main surface of the cholesteric liquid crystal layer was 43°. In addition, the interval of the bright portions and the dark portions was 0.85 μm.

### Preparation of Transparent Screen 2

A transparent screen 2 was prepared using the same method as that of Example 1, except that, after the application of the shearing force during the preparation of the transparent screen 1, the cholesteric liquid crystal layer was irradiated (exposure amount: 2 mJ/cm²) with a ultraviolet ray from a metal halide lamp through a long wavelength cut filter (manufactured by Asahi Spectra Co., Ltd., SH0325), the long wavelength cut filter was removed, and the cholesteric liquid crystal layer was irradiated (exposure amount: 500 mJ/cm²) with an ultraviolet ray using a metal halide lamp in a nitrogen atmosphere (oxygen concentration: less than 100 ppm).

<Tilt angle of Bright Portions and Dark Portions>

The transparent screen 2 prepared as described above was cut in a thickness direction, a cross-sectional image was observed with a SEM, and it was verified that the angle β between the bright portions and the dark portions and the main surface of the cholesteric liquid crystal layer was 62°. In addition, the interval of the bright and dark portions was 0.85 μm.

### <Preparation of Transparent Screen 3>

A transparent screen 3 including a light scattering layer including light scattering particles was prepared with reference to Example 9 of JP-2019-174546A.

### Evaluation

Each of the transparent screens including the cholesteric liquid crystal layer or the light scattering layer prepared as described above was prepared at a size of 15 square cm and was bonded to a transparent glass plate using a pressure sensitive adhesive (SK pressure sensitive adhesive, manufactured by Soken Chemical Co., Ltd.). In this case, the cholesteric liquid crystal layer side was the glass side.

Next, a video was projected to the transparent screen using a projector (manufactured by BenQ Corporation, MH550).

As the video, an image where black “FUJIFILM” was disposed at the center of the entire white surface was used. In this case, the projector and the transparent screen were disposed such that the angle θ₁ between the ray of the video light emitted from the projector and the normal line of the transparent screen was 20°, 30°, 45°, or 60°, and the image visibility was checked by visual inspection. The case where the angle θ₁ was 20° corresponds to Comparative Example, and the cases where the angle θ₁ was 30°, 45°, and 60° correspond to Examples.

The results are shown in Table 1.

TABLE 1

| | Angle θ₁ | | | |
|---|---|---|---|---|
| Image Visibility | 20° | 30° | 45° | 60° |
| Transparent Screen 1 | Bad | Good | Very Good | Good |
| Transparent Screen 2 | Bad | Good | Good | Very Good |
| Transparent Screen 3 | Bad | Good | Very Good | Good |

It was verified from Table 1 that, by setting the angle θ₁ to be 30° or more, linearly transmitted light is not likely to adversely affect on the video and high image visibility can be obtained.

In addition, a haze and a total light transmittance of each of the transparent screens were measured using a haze meter NDH-2000 (manufactured by Nippon Denshoku Industries Co., Ltd). The results are shown in Table 2.

Here, the total light transmittance is a value of (Diffuse Transmittance of Natural Light at 380 to 780 nm+Direct Transmittance of Natural Light)×100%.

TABLE 2

| | | Total Light |
|---|---|---|
| | Haze [%] | Transmittance [%] |
| Transparent Screen 1 | 15 | 90 |
| Transparent Screen 2 | 16 | 88 |
| Transparent Screen 3 | 25 | 80 |

The effects of the present invention are obvious from the above results.

### EXPLANATION OF REFERENCES

10: light projection layer
10a: cholesteric liquid crystal layer
10b: light scattering layer
40: liquid crystal compound
40A: optical axis
42: bright portion
44: dark portion
50: light scattering particles
52: base material
100: display system for rear projection
102: transparent screen
103: rear surface
104: front surface
106: support
110: projection device
110a: projection opening
150: application device
200: drying device
300: blade
400: light source
500, 510: transport roll
600, 610: backup roll
θ₁: angle
I₁: video light
I₂: linearly transmitted light
U: observer
D₁: arrangement axis
C₁: helical axis
β: angle

What is claimed is:

1. A display system for rear projection comprising:
a projection device that emits video light; and
a transparent screen on which the video light emitted from the projection device is projected,
wherein at a point that is positioned on the video light projected on the transparent screen and is closest to a projection opening of the projection device, an angle θ₁ between a ray of the video light projected on the point and a normal line of the transparent screen is 30° or more.

2. The display system for rear projection according to claim 1,
wherein the angle θ₁ is 30° to 60°.

3. The display system for rear projection according to claim 1,
wherein the transparent screen includes a light projection layer that directs the projected video light toward a visible side, and
a film thickness of the light projection layer is 0.1 μm to 30 μm.

4. The display system for rear projection according to claim 3,
wherein the film thickness of the light projection layer is 2 μm to 12 μm.

5. The display system for rear projection according to claim 3,
wherein the light projection layer is a light scattering layer that includes light scattering particles, and
the angle θ₁ is 45° to 60°.

6. The display system for rear projection according to claim 3,
wherein the light projection layer is a cholesteric liquid crystal layer,
in a cross section perpendicular to a main surface of the cholesteric liquid crystal layer, a bright portion and a dark portion derived from a cholesteric liquid crystalline phase observed with a scanning electron microscope are tilted with respect to the main surface of the cholesteric liquid crystal layer, and
the angle θ₁ is 30° to 60°.

7. The display system for rear projection according to claim 6,
wherein the bright portion and the dark portion of the cholesteric liquid crystal layer are tilted by 20° to 90° with respect to the main surface of the cholesteric liquid crystal layer.

8. The display system for rear projection according to claim 1,
wherein a haze of the transparent screen is 25% or less.

9. The display system for rear projection according to claim 1,
wherein a light transmittance of the transparent screen is 80% or more.

10. The display system for rear projection according to claim 2,
wherein the transparent screen includes a light projection layer that directs the projected video light toward a visible side, and
a film thickness of the light projection layer is 0.1 μm to 30 μm.

11. The display system for rear projection according to claim 10,
wherein the film thickness of the light projection layer is 2 μm to 12 μm.

12. The display system for rear projection according to claim 10,
wherein the light projection layer is a light scattering layer that includes light scattering particles, and
the angle θ₁ is 45° to 60°.

13. The display system for rear projection according to claim 10,
wherein the light projection layer is a cholesteric liquid crystal layer,
in a cross section perpendicular to a main surface of the cholesteric liquid crystal layer, a bright portion and a dark portion derived from a cholesteric liquid crystalline phase observed with a scanning electron microscope are tilted with respect to the main surface of the cholesteric liquid crystal layer, and
the angle θ₁ is 30° to 60°.

14. The display system for rear projection according to claim 13,
wherein the bright portion and the dark portion of the cholesteric liquid crystal layer are tilted by 20° to 90° with respect to the main surface of the cholesteric liquid crystal layer.

15. The display system for rear projection according to claim 2,
wherein a haze of the transparent screen is 25% or less.

16. The display system for rear projection according to claim 2,
wherein a light transmittance of the transparent screen is 80% or more.

17. The display system for rear projection according to claim 4,
wherein the light projection layer is a light scattering layer that includes light scattering particles, and
the angle θ₁ is 45° to 60°.

18. The display system for rear projection according to claim 4,
wherein the light projection layer is a cholesteric liquid crystal layer,
in a cross section perpendicular to a main surface of the cholesteric liquid crystal layer, a bright portion and a dark portion derived from a cholesteric liquid crystalline phase observed with a scanning electron microscope are tilted with respect to the main surface of the cholesteric liquid crystal layer, and
the angle θ₁ is 30° to 60°.

19. The display system for rear projection according to claim 18,
wherein the bright portion and the dark portion of the cholesteric liquid crystal layer are tilted by 20° to 90° with respect to the main surface of the cholesteric liquid crystal layer.

20. The display system for rear projection according to claim 3,
wherein a haze of the transparent screen is 25% or less.
